(19) United States
(12) Patent Application Publication
(10) Pub. No.: US 2019/0045823 A1
(43) Pub. Date: Feb. 14, 2019

(54) A PROCESS FOR MAKING A LIQUID LOW SODIUM FOOD-GRADE SALT

(71) Applicants: Maria De Los Angeles GARCIA, Bagno di Gavorrano (GR) (IT); Maria Fernanda GARCIA, Follonica (IT)

(72) Inventors: Maria De Los Angeles GARCIA, Bagno di Gavorrano (GR) (IT); Maria Fernanda GARCIA, Follonica (IT)

(73) Assignees: Fernando Horacio GARCIA, Follonica (GR) (IT); Armando Horacio PIERONI, Scarlino (GR) (IT)

(21) Appl. No.: 16/079,213

(22) PCT Filed: Mar. 8, 2017
(86) PCT No.: PCT/IB2017/051370

§ 371 Date: Aug. 23, 2018

(30) Foreign Application Priority Data
Mar. 8, 2016 (IT) 102016000023917

(51) Int. Cl. A23L 27/40

(52) U.S. Cl. CPC A23L 27/40; A23V 2002/00

(57) ABSTRACT

A process for making a liquid low-sodium food-grade salt (100), wherein a mixture (20) contains water (1), sodium chloride (2) at an amount set between 14% and 26% by weight, alimentary acceptable anions (4) selected among carbonate, iodate, acetate, ascorbate, citrate, propionate, tartrate and sorbate ions at a concentration between 0.1% and 5% by weight. This reduce the electrostatic forces between sodium ions and chloride ions, increasing the ionic mobility with respect to a solution containing the same amount of NaCl only. This increases the tastefulness of the mixture, i.e. it provides a stronger perception of the salty taste by a subject. Moreover, the mixture can undergo to diffusion (17) of a gas (7), which increases kinetic energy and, therefore, further increases ionic mobility.

### FIELD OF THE INVENTION

The present invention relates to a process for making a liquid low-sodium food-grade salt.

### ANTECEDENTS OF THE INVENTION

Traditionally, in order to obtain a low-sodium food-grade salt, sodium chloride, NaCl, is partially replaced by potassium chloride, KCl. KCl has a salty taste like NaCl, but it also has a bitter aftertaste. For this reason, people do not usually like low-sodium food-grade salt obtained this way. Moreover, the potassium concentration required to obtain a reasonable sodium reduction cannot be accepted by those who suffer from chronic renal insufficiency, and by dialyzed patients.

It is well known that the maximum tasty effect is obtained if sodium chloride is dissolved in water close to the saturated state, when it comes into contact with a consumer's tongue. No sodium chloride concentration control is possible if common solid kitchen salt is used, which causes consumers to overuse salt in order to obtain a desired tastefulness, and to overtake much more salt than what is required.

In order to overcome this problem, EP1543733 proposes a process to make liquid food-grade salt in which the NaCl concentration is close to the saturated state, starting from seawater. For this, factories should be established not far from the sea. In any case, high capital and maintenance costs would be involved to supply highly corrosive seawater to the factories, in connection with seacocks, pumps, pipelines and various equipment. Moreover, seasonal changes in the quality, and possible seawater pollution, could require additional treatment and/or unfavourably affect the quality of the final product.

In any case, the consumers require such products with a tasty effect stronger than those currently available on the market.

U.S. Pat. No. 6,048,569 describes a liquid low-sodium food-grade salt, and a method for its production, obtained by seawater decantation, evaporation and sterilization. An example of this product contains 0.29% sulphate anions, 0.017% wt. sodium bicarbonate, which corresponds to 0.012% wt. bicarbonate, and minor amounts of nitrate anions.

Jeannine F. Delviche et al., in Anion Size of Sodium Salts and Simple Taste Reaction Times, Physiology and Behaviour, vol. 66, no. 1, March 1999 (1999-03), pages 27-32 examine possible relationships between some sodium salts and respective taste reaction times by a group of selected subjects. The subjects were presented a normalized water solution of each of five sodium salts (chloride, acetate, monosodium glutamate, ascorbate, gluconate) and a sample of pure water, in a random order, in which each liquid was presented three times. The subjects were asked to point out the time at which they felt the taste of each subsequently presented solution, and to provide a rating of the intensity they perceived once each solution had been presented to them. Each presented solution contained one salt only, and sodium chloride was therefore present alone in one solution only. The results of this study provide therefore a comparison between different sodium salts, and do not allow establishing the effect of the presence of salts different from sodium chloride, i.e. of the presence of anions different form chloride, on the perception of the taste of sodium chloride.

KR 2014 0024629 A describes a method and an apparatus for purifying pond salt by aerobic bacteria, wherein a step is provided of vibrating a pond salt mass previously washed and subjected to cultivation of aerobic bacteria, by applying ultrasounds and high pressure air.

### SUMMARY OF THE INVENTION

It is a feature of the present invention to provide a liquid low-sodium food-grade salt that has a tastefulness, i.e. a salty power, higher than similar liquid products that are presently available on the market.

It is then a feature of the invention to provide such a low-sodium food-grade salt that solves the above-mentioned bitter aftertaste problem due to potassium chloride, and in which only an amount of potassium can be required that is not harmful for subjects suffering from kidney diseases or insufficiency.

It is also a feature of the invention to provide such a liquid food-grade salt, which does not provide seawater among the raw materials.

These and other objects are achieved by a process for making a liquid low-sodium food-grade salt, comprising the steps of:
preparing a mixture of:
   an amount of water;
   an amount of sodium chloride set between 14% and 26% by weight;
   an amount of alimentary acceptable anions set between 0.1% and 5% by weight,
wherein said amount of water is the complement to 100% of said mixture,
wherein said alimentary acceptable anions are selected from the group comprised of:
   bicarbonate anions;
   carbonate anions;
   borate anions;
   acetate anions;
   ascorbate anions;
   citrate anions;
   propionate anions;
   tartrate anions;
   sorbate anions;
   a combination thereof.

This way, the mixture thus obtained can be directly used as a general table condiment having an improved tasty yield.

As well known, in a water solution, a strong electrolyte such as NaCl is completely dissociated into Na⁺ and Cl⁻ ions. If no electric field is present, each positive Na⁺ ion is generally surrounded by Cl⁻ ions, and vice-versa. In the solution, the ionic mobility of Na⁺ and Cl⁻ ions is higher than in the solid state. However, even if Na⁺ and Cl⁻ ions are dissociated, the mutual attraction forces are still important, therefore the ionic mobility is in any case restricted.

Once they have been introduced into a sodium chloride solution, according to the invention, the above-mentioned anions interact with Na⁺ and Cl⁻ ions already present in the solution. As diagrammatically shown in FIG. 1, it is believed that any Na⁺ ion is surrounded by negative anions A⁻. Therefore anions A⁻ partially “shield” the positive charge of Na⁺ ion, but the group consisting of a Na⁺ ion and the surrounding A⁻ anions has however an overall positive charge that is lower than the one of Na⁺ ion alone. For this reason, the electrostatic forces between Na⁺ ions and Cl⁻ ions, if the A⁻ anions are present, is lower, and Na⁺ and Cl⁻ ions are statistically farther from one another than in the case of a water solution containing sodium chloride ions only. Therefore, if A⁻ anions are present the ionic mobility of Na⁺ ions is higher.

As well known, the salty taste of sodium chloride depends on sodium ions, which enter into the taste receptor cells through ion-channels known as amiloride-sensitive Na⁺ channels. It is believed that the more sodium ions are free to move, i.e. the more they are free to enter into the taste-related channels, the the more the salty taste is enhanced.

Therefore, dissolved anions, by increasing the relative mobility of sodium ions, increase the tastefulness of the liquid food-grade salt. In other words, a food-grade salt is obtained that has a predetermined salty power, but contains less sodium. Starting by sodium chloride simply dissolved into water, which is the easiest way to obtain liquid table salt, and adding such anions, a much higher tastefulness can be obtained than the starting liquid salt, without further taking sodium. Therefore, a smaller amount of liquid salt can be satisfactorily used when seasoning food at table.

All this can be advantageously described by the z-potential of the solution that, as well known, provides a measurement of repulsive and attractive forces mutually exerted by charge particles in a solution, and is related with the ionic mobility of the ions present in the solution. To this purpose, some of the attached examples indicate the results of ionic mobility measurements and of zeta potential determinations, along with the composition of some mixtures according to the invention. These results show that, by adding a predetermined amount of each anion, the zeta potential and the ionic mobility increase with respect to the value measured in a solution containing sodium chloride only, in this case, in a solution close to the saturated state. Moreover, taste trials with these mixtures have shown that the solutions exhibiting the higher zeta potential and ionic mobility values were always tastier, with reference to the salty taste.

Therefore, the process advantageously provides a step of determining the zeta potential of the water solution, through one of the available well-known techniques, and/or a step of measuring the ionic mobility. In particular, said amount of anions is selected so as to obtain a zeta potential of said mixture higher than a zeta potential of a reference sodium chloride water solution containing the same amounts of water and sodium chloride, or it is selected so as to obtain a ionic mobility of said mixture higher than a ionic mobility of said reference solution.

The technique for determining the zeta potential can be based, for instance, on electrophoretic mobility measurements of the ions, or on titration based on pH value, on electric conductivity, on density, on viscosity or on concentration of determined additives.

A further advantage of the process according to the invention is that the use of seawater is not provided, therefore large works such as pipelines from the seacocks to the production units are not required. On the contrary, the sodium chloride-containing corrosive solution comes into contact with few equipment and pipes. This reduces maintenance and operation costs of the production plants, in comparison to the cited prior art products.

According to a possible implementation of the method of the invention, the process comprises a step of causing bubbles of a gas to diffuse through the mixture. This allows a better separation of the ions that are present in the solution, and a higher stability with time.

Advantageously, the process provides a step of determining the zeta potential of the water solution, and/or a step of a measuring its ionic mobility, after starting said gas diffusion step. In particular, the diffusion step e is continued until a zeta potential of said mixture is reached that is higher than a zeta potential of a reference sodium chloride water solution containing the same amounts of water and sodium chloride, or until a ionic mobility of said mixture is reached that is higher than a ionic mobility of said reference solution.

The gas bubbles diffusion step can comprise the steps of:
causing the mixture to flow through a diffusion duct that has an inlet port and an outlet port defining a passageway of the mixture, and has an intermediate restricted throat section, in particular through a Venturi-type diffusion duct;
simultaneously sucking the gas to be diffused at the restricted section by the mixture flowing through the passageway,
wherein the ratio between the flowrate of the gas and the flowrate of the mixture can be set between 0.3 and 2 Nm³/m³, preferably between 0.5 and 1 Nm³/m³. The use of such a device, in particular of a Venturi-type duct, enhances the previously described effect as an hysteresis effect. In fact, this way, during the step of causing the gas bubbles to diffuse, an emulsion is formed, i.e. a metastable state that temporary accumulates energy.

As an alternative, the gas bubble diffusion step can comprise a step of bubbling the gas to be diffused in a reservoir containing the mixture, and this step of bubbling is continued for a predetermined bubbling time. The step of bubbling can be carried out in the same reservoir where the mixture has been prepared.

In particular, the step of bubbling comprises a step of supplying the gas to the reservoir through a delivery mouth in use arranged below the level of the mixture, and having a supply head configured for forming and delivering micrometric gas bubbles.

For instance, the gas used in the diffusion step is selected among air, carbon dioxide, helium, argon, or a combination thereof. Preferably, this gas is air. In fact, air is far cheaper, and more soluble into the liquid, than other gases, which prolongs the hysteresis effect caused by the gas diffusion step. During the diffusion step, air tends to form an emulsion at first and then is solubilized. A dynamic balance is then established between emulsion air and the air dissolved in the solution.

In an exemplary embodiment, the anions comprise bicarbonate anions, the gas used for the diffusion step is a gas containing carbon dioxide besides air or besides one of the above-mentioned gases, at a volume fraction set between 10% and 30%, preferably between 15% and 25%, and the step of causing the gas bubbles to diffuse through the mixture is continued until an amount of bicarbonate ions is added that is at most equal to said predetermined amount of anions. In other words, if a gas is caused to diffuse which contains such a carbon dioxide fraction, the gas diffusing through the mixture also provides the source of the anions, in this case, bicarbonate anions. This makes the process simpler, since the diffusion step is carried out at least in part simultaneously with a step of supplying i.e. adding anions. In this case, the gas is preferably an air-carbon dioxide mixture.

Before the step of feeding the gas, i.e. before supplying an amount of carbon dioxide, a step can be provided of adding a preferably sodium-free alkaline agent to the mixture, in order to adjust the pH of the mixture to a initial pH value set between 8 and 8.5, and the step of feeding the carbon dioxide-containing gas proceeds until a predetermined final pH value is reached, in particular, set between 7.2 and 7.8, more in particular, about 7.5. This makes easier to incorporate the gas or the air during the diffusion step.

As well known, carbonate ions are always present along with bicarbonate anions, according to a well-known ionic equilibrium. In particular, the bicarbonate ions and the carbonate ions have respective concentrations at most equal to 0.2% by weight, with respect to the weight of the solution.

The step of preparing the mixture can comprise the steps of:
prearranging said amount of water having a conductivity ≤10 μS;
prearranging said amount of alimentary acceptable solid sodium chloride, in particular food-grade salt, selected from the group consisting of:
   rock salt, i.e. sodium chloride extracted from an underground salt mine;
   vacuum salt, i.e. sodium chloride obtained by crystallizing a saturated sodium chloride solution,
dissolving the amount of solid sodium chloride into the amount of water, in order to form a sodium chloride water solution.

The electric conductivity is a measurement of the purity degree of the water that has been used, i.e., of the absence of electrolytes and other foreign substances. Pure water can be obtained by treating water with reverse osmosis and/or by distilling it, or by supplying water obtained by at least one of these treatments.

In particular, the step of preparing the mixture comprises a step of feeding to said sodium chloride-containing solution, a compound adapted to form one of the anions, when brought into contact with water, in particular this compound is an alimentary acceptable salt of one of the anions. Preferably, this salt is sodium-ion free.

In an exemplary embodiment, the amount of sodium chloride is set between 18% and 26% by weight, in particular it is set between 23% and 26% by weight, more in particular, it is set between 24.5% and 25.5%, even more in particular, the amount of sodium chloride is about 25% by weight.

In an exemplary embodiment, the amount of alimentary acceptable anions is set between 0.1% and 0.5% by weight.

The mixture can comprise a certain amount of potassium chloride KCl, less than 13% by weight. In this case, the amount of anions preferably comprises citrate anions in a proportion set between 1% and 9% by weight with respect to the weight of potassium chloride. Actually, it has been observed that such an amount of potassium citrate can suppress the typical bitter aftertaste of any potassium chloride-containing salt.

In an exemplary embodiment, the solid sodium chloride comprises an amount of sea salt having a determined concentration of such alimentary acceptable anions, wherein the amount of sea salt is selected to provide the mixture with an amount of anions that is at most equal to the predetermined amount of anions.

In particular, the amount of sea salt is set between 10% and 40% by weight with respect to total solid sodium chloride, in particular the amount of sea salt is set between 18% and 25% by weight, more in particular, the amount of sea salt is about 20%.

Advantageously, the process comprises a step of adding to the mixture a substance arranged to provide iodine in an assimilable form, for instance, selected between potassium iodate and potassium iodide, until a predetermined iodine content is reached in the solution, so as to obtain a food-grade iodide- or iodate-containing salt formulation, respectively, which is also a low-sodium salt formulation providing the well-known health advantages to the consumers.

Advantageously, the process comprises a step of filtering the mixture, which preferably provides steps of causing the mixture to flow through filters whose mesh size decreases from a preceding filter to a subsequent filter. Preferably, the mesh size of the filter or of the filters is set between 20 μm and 1 μm.

It falls within the scope of the invention also a liquid low-sodium food-grade salt manufactured as described.

The invention allows therefore to make low-sodium food products of substantially any kind, without all the drawbacks of the presently available solid or liquid low-sodium food-grade salt types, in particular, taste change, unsuitability for those who are not allowed to take too much potassium, such as people suffering from kidney insufficiency and diseases in general, and, in any case, unsatisfying salty power, according to many consumers, which could induce them to overtake these substances.

### BRIEF DESCRIPTION OF THE DRAWINGS

The invention will be now shown with the following description of its exemplary embodiments, exemplifying but not limitative, with reference to the attached drawings in which:

FIG. 1 diagrammatically shows the effect of the anions on the interactions between ions Na⁺ and ions Cl⁻ in a salt containing sodium chloride;

FIG. 2 is a block diagram of a process, according to the invention, to obtain a liquid low-sodium food-grade salt;

FIG. 2A is a block diagram of a process, according to the invention, to obtain a liquid low-sodium food-grade salt, in which a gas bubbles diffusion step is provided;

FIG. 3 is a block diagram of a process according to the invention, in which the anions are introduced into the solution during the gas bubbles diffusion step;

FIGS. 4 and 5 are block diagrams of processes according to the invention, in which a filtration step is provided;

FIGS. 6 and 7 are block diagrams of processes, according to the invention, for making liquid iodide- or iodate-containing low-sodium food-grade salt;

FIG. 8 diagrammatically shows a Venturi-type duct for carrying out the gas bubbles diffusion step;

FIGS. 9 and 10 are block diagrams of further processes, according to the invention, providing the features of the processes of FIGS. 4 and 6, and of 5 and 7, respectively;

FIG. 11 is a flow-sheet of apparatuses for putting the process according to a modification of FIG. 9 into practice;

FIGS. 12 and 13 are flow diagrams for putting the process according to FIG. 9 or FIG. 10 into practice, wherein a gas diffusion step through the mixture is provided according to two process modifications.

### DESCRIPTION OF EXEMPLARY EMBODIMENTS OF THE INVENTION

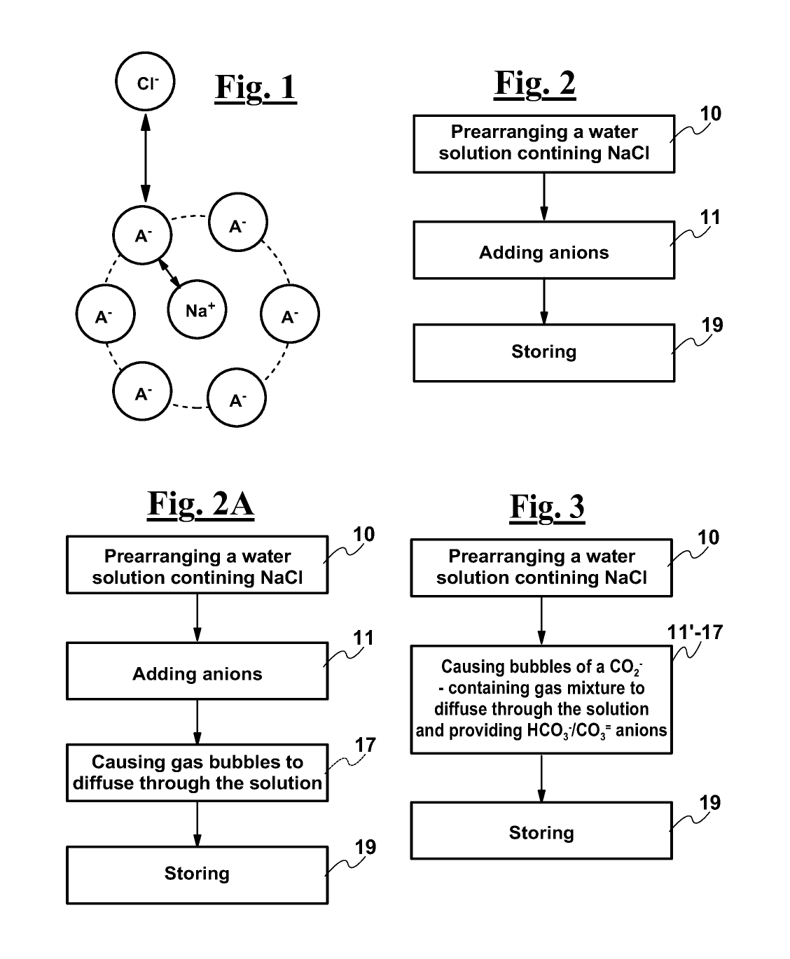

With reference to FIG. 2, and to the flow diagrams of FIGS. 11-13, a process for making a liquid low-sodium food-grade salt 100 comprises a step 10 of prearranging an amount of a mixture 20 containing sodium chloride at a concentration set between 18% and 26% by weight, more in particular, between 24.5% and 25.5%. Mixture 20 is subjected to a step 11 of adding alimentary acceptable anions 4, until an anion concentration is reached between 0.1% and 0.5% by weight, with respect to whole solution 20. FIGS. 11-13 show apparatuses for making the liquid food-grade salt according to the invention.

Step 10 of prearranging solution 20 typically comprises steps, not shown of prearranging pure water 1 and pure solid sodium chloride 2. The purity degree of the water can be indicated, in particular, by an electric conductivity of at most 10 μS, which can be obtained, for instance, by reverse osmosis and/or distillation methods. Solid salt 2 comprises, in particular, food-grade rock salt, or also vacuum salt, which is obtained by crystallizing a saturated sodium chloride solution.

In this case, solution 20 is prepared by a step of dissolving sodium chloride 2 into water 1. As shown in FIGS. 11-13, this can be carried out in a reservoir 30 equipped with a stirrer 31, for example by feeding sodium chloride 2 from a feed reservoir 21 such as a hopper, or by a different loading system, until an amount is reached corresponding to a desired concentration of sodium chloride in solution 20.

Stirrer 31 is configured in such a way to speed up the mixing of sodium chloride and water, and to form mixture 20 efficiently. Preferably, stirrer 31 is equipped with hollow blades, in particular frustoconical blades, which are preferably arranged with their own longitudinal axis in a horizontal direction.

Anions 4 are selected among inorganic anions such as bicarbonate anions, carbonate anions, borate anions, iodate anions, and/or among organic anions such as acetate anions, ascorbate anions, citrate anions, propionate anions, tartrate anions and sorbate anions. However, it cannot be excluded that the effect of increasing the ionic mobility and subsequently increasing the mobility by adding anions, is obtained by adding ions different from the above, provided that they are alimentary acceptable.

In particular, concerning anions 4, the preparation of solution 20 can provide a step of feeding one or more compounds adapted to form, when brought into contact with water 1, one or more respective anions 4. These compounds are preferably alimentary acceptable salts of such respective anions 4. To this purpose, a conventional feed means 22 can be provided that is are arranged for containing these compounds or salts and for metering them into reservoir 30 as a solid or as a water solution, which is diagrammatically shown in FIGS. 11-13.

As anticipated with reference to FIG. 1, anions 4 have the effect of interposing between cations Na⁺ and anions Cl⁻. This way, the electrostatic forces between Na⁺ ions and Cl⁻ ions become weaker, which increases sodium ions ionic mobility, and make the water solution more tasteful.

Solid sodium chloride 2 can also comprise an amount of sea salt having a known concentration of anions 4, in order to provide at least one part the required anions. These anions are those that are normally present in seawater, for instance bicarbonate ions HCO₃⁻. To this purpose, the sea salt can be prepared as a suitable mixture with rock salt in feed reservoir 21 of FIGS. 11-13, or it is prepared in a metering tank different from reservoir 21.

In this case, the sea salt ratio is chosen so as to provide a concentration of anions 4 in mixture 20 that is at most equal to the predetermined anions concentration, in particular it is set between 10% and 40% by weight with respect to solid sodium chloride 2, more in particular, between 18% and 25% by weight, even more in particular, it is about 20%, the remainder typically consisting of rock salt. Preferably, the amount of sea salt corresponds to NaCl concentration in seawater, which is about 3.6%. For example, in a mixture 20 containing 25% by weight of total sodium chloride, the contributes of rock salt and of sea salt are respectively 21.4% and 3.6%, the latter corresponding to 14.4% with respect to total weight of solid NaCl.

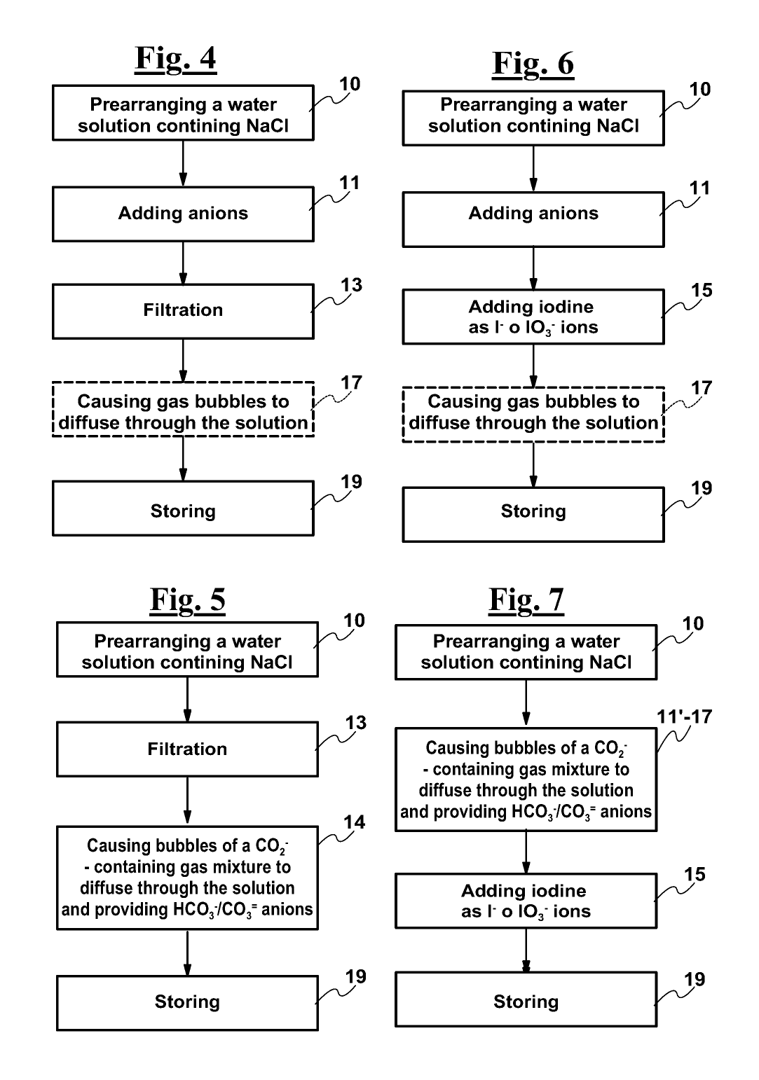

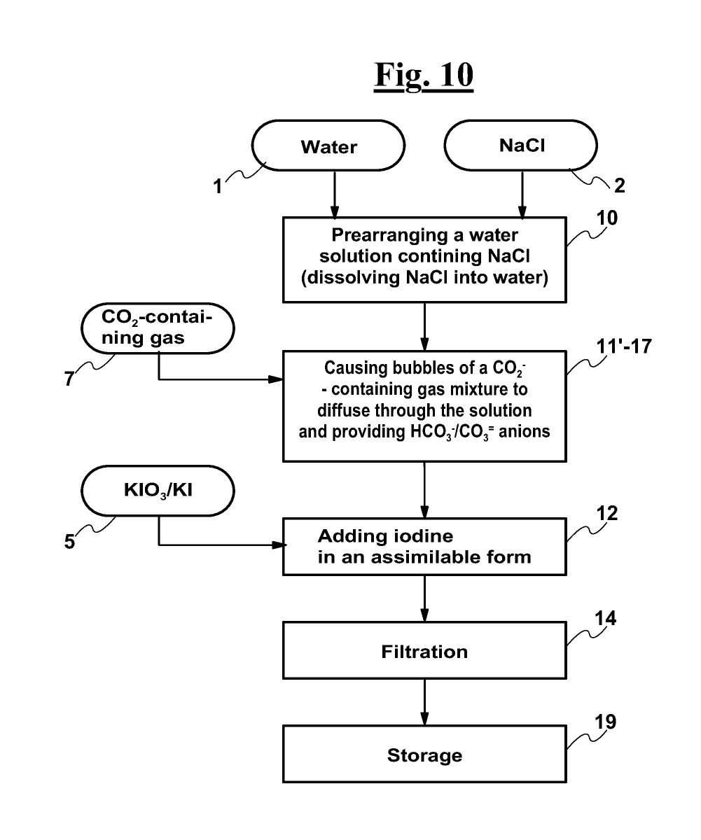

As shown in FIG. 2A, as well as in FIGS. 4, 6, 9, where the dotted lines stand for optional features, and by FIG. 10, the process may also comprise a step 17 of causing a gas 7 to diffuse through the water solution, wherein a step 17 of causing gas bubbles 7 to diffuse is carried out so as to obtain an increase of the zeta potential of mixture 20 above a predetermined value.

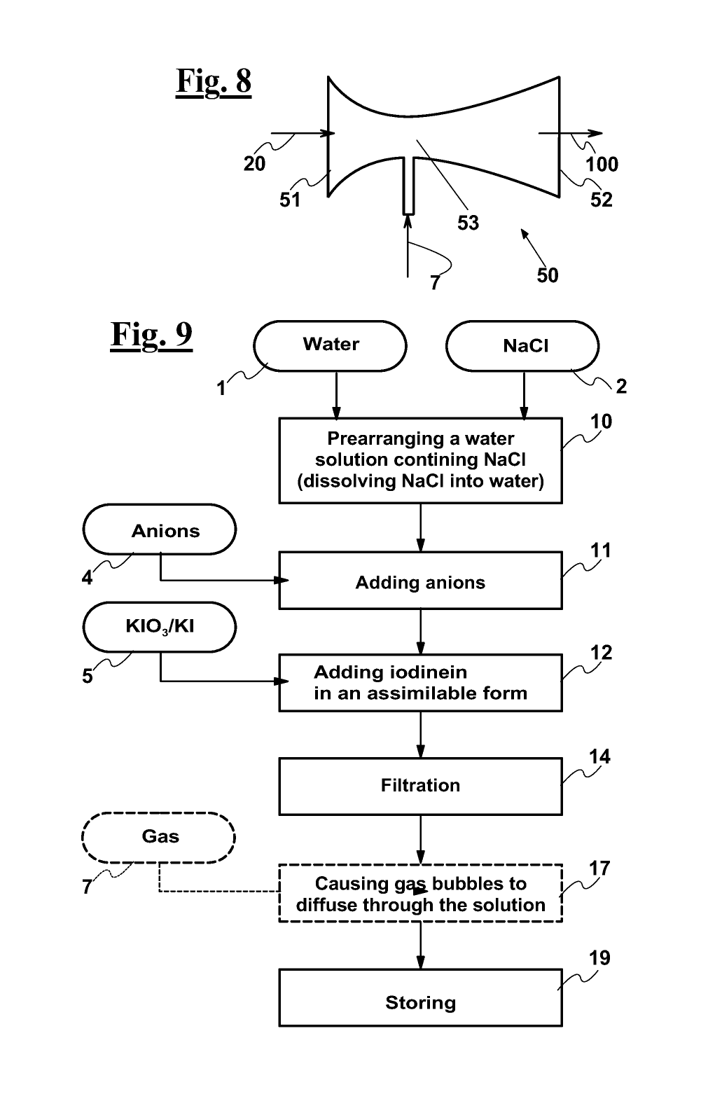

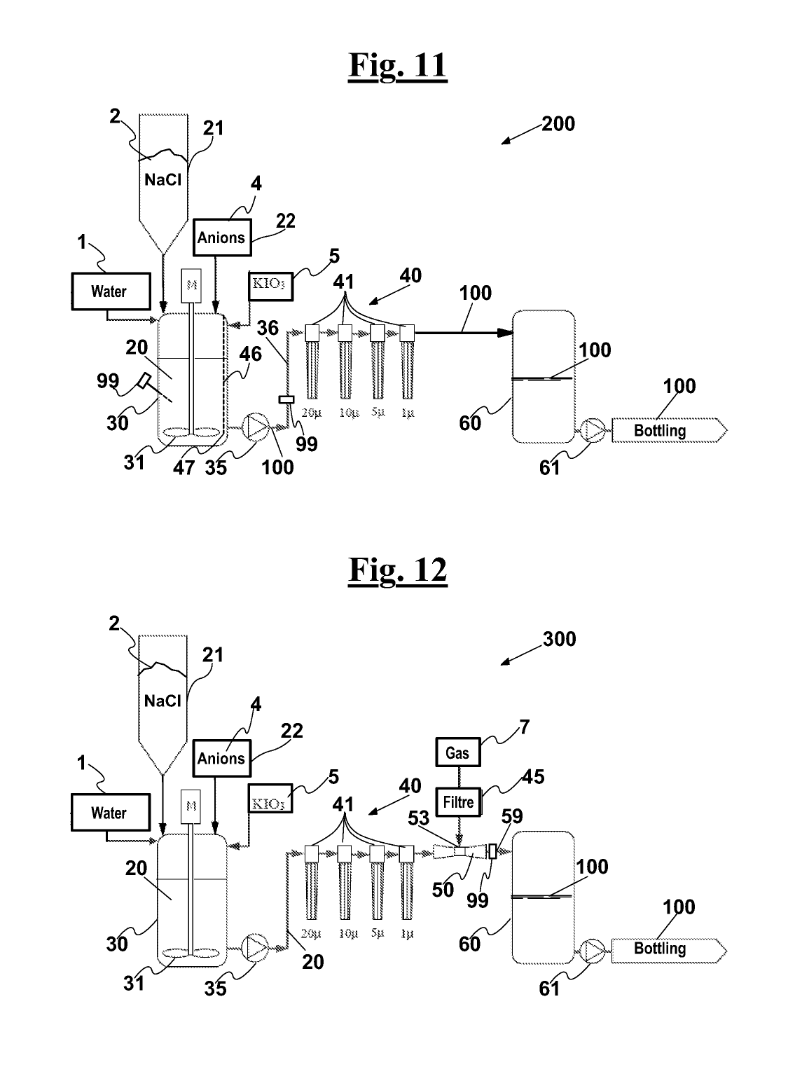

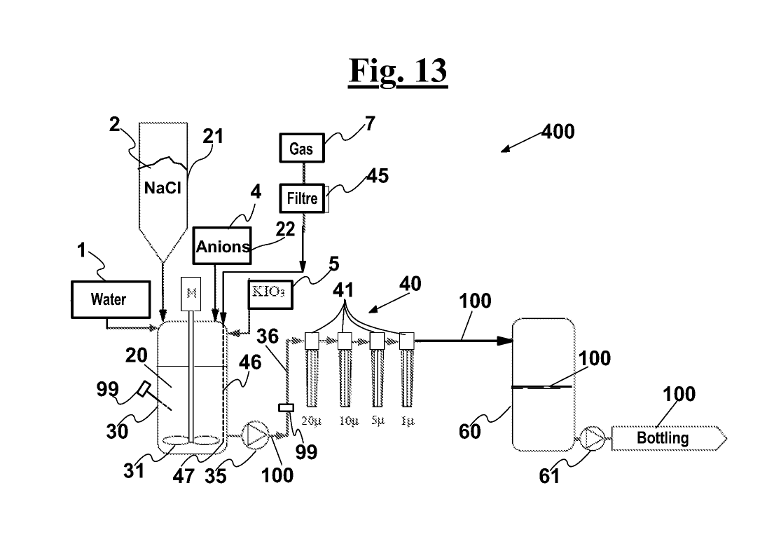

FIGS. 12 and 13 differ from FIG. 11 in that they show a means for carrying out step 17 of causing gas bubbles 7 to diffuse. In particular, as shown in FIG. 12, the diffusion step of can be carried out by causing mixture 20 to flow through a diffusion duct 50, in particular through a Venturi-type duct 50, as shown in FIG. 8, that has an inlet port 51 for mixture 20 and an outlet port 53 for liquid low-sodium salt 100, and has an intermediate restricted throat section 53 therebetween, at which a stream of a gas 7, in particular air, is fed or more precisely sucked. In this case, a filter 45 is preferably provided before the inlet to diffusion duct 50.

The ratio between the flowrate of gas 7 and the flowrate of mixture 20 in diffusion duct 50 is preferably set between 0.3 and 2 Nm³/m³, in particular it is set between 0.5 and 1 Nm³/m³.

As an alternative, with reference to FIG. 13, step 17 of causing gas bubbles 7 to diffuse can comprise a step of bubbling the gas in a reservoir containing mixture 20, in particular in reservoir 30 where mixture 20 is formed. In this case, the step of bubbling comprises a step of supplying gas 7 to reservoir 30 through a delivery mouth 47 in use arranged below the level of mixture 20, and preferably having a supply head, not shown, configured for forming and delivering air bubbles whose size is at most micrometric. Preferably, a partially submerged feed duct 46 is provided in reservoir 30 for introducing gas 7 thereinto, having a vertical portion in use submerged by mixture 20.

Preferably, submerged end 47 of duct 46, which is arranged below the level of mixture 20, has a supply head, not shown, configured for forming and delivering gas bubbles of a predetermined size, in particular for forming air bubbles whose size is about one micron, i.e. microbubbles.

Also in this case and, in particular, if air 7 that must diffuse is taken from the environment by a compressor or by a fan, a filter 45 is preferably provided before the inlet into partially submerged fed duct 46.

With reference to FIG. 3, for a formulation in which anions 4 comprise bicarbonate anions, the step of adding anions 4 can comprise a step 11′ of causing a CO₂-containing gas to diffuse, which can be, at least in part, the same step as previously-described step 17 of causing diffusion bubbles of gas 7. In this case, gas 7 has a predetermined CO₂ concentration set between 10 and 30%, preferably between 15% and 25%, more preferably this concentration is about 20%.

Even step 11′ of causing CO₂-containing gas 7 to diffuse can be performed in a Venturi-type duct 50 (FIG. 13), like step 17, or by a partially submerged feed duct 46 (FIG. 14). In both cases, a step can however be provided of feeding one or more compounds adapted to form one or more respective anions 4 different from bicarbonate ion, through above-mentioned feed means 22.

As well known, carbon dioxide reacts with water forming carbonic acid, H₂CO₃, which is unstable and cannot be isolated, and generates bicarbonate ions. The concentrations of carbonic acid, which is present as free CO₂ in the solution, of hydronium ion H₃O⁺ and of bicarbonate and carbonate ions in water solution follow the relationships describing the acid dissociation equilibrium reactions:

H₂O+H₂CO₃↔HCO₃_{^{−}}+H₃O⁺,Kₐ₁=[HCO₃_{^{−}}].[H₃O⁺]/[H₂CO₃]4.4·10⁻⁷ mol/L,

and

H₂O+HCO₃_{^{−}}↔CO₃_{⁼}+H₃O⁺,Kₐ₂=[CO₃_{⁼}].[H₃O⁺]/[HCO₃_{^{−}}]=4.8·10⁻¹¹ mol/L,

wherein Kₐ₁ and Kₐ₂ are the respective equilibrium dissociation constants. From the above, it follows that at pH values lower than 6.4, H₂CO₃ prevails in the solution and decreases as the pH value approaches 6.4, at which value the same amount of both chemical species H₂CO₃ and HCO₃_{^{−}} is present. On the contrary, for pH values between 6.4 and 8.3, the HCO₃_{^{−}} increases until it reaches 100% at pH 8.3. Beyond this value, carbonate ion CO₃_{⁼} begins to form.

For this reason, before step 11′ of causing carbon dioxide-containing gas 7 to diffuse, a step, not shown, is advantageously provided of adding a preferably sodium-free alkaline agent. This serves for adjusting the pH of mixture 20 to a starting value set between 8 and 8.5. Subsequently, gaseous CO₂ starts, which decreases pH. Therefore, the CO₂ supply must be cut off when the pH has reached a final value between 7.2 and 7.8, in particular about 7.5, in order to ensure that bicarbonate ion is the prevailing chemical species, among the species that are involved in the above-mentioned dissociation equilibrium reactions.

In other words, diffusion step 11′ is continued until the predetermined bicarbonate concentration is reached in mixture 20, which is lower than or equal to the overall concentration of anions 4, as indicated above, according to whether anions 4 different from bicarbonate are provided or not. The carbon dioxide volume fraction can therefore be advantageously selected, within the above-indicated field, in such a way to obtain the predetermined ionic mobility, i.e. the predetermined zeta potential value in solution 20 and, at the same time, to obtain the predetermined bicarbonate concentration, thus providing liquid food-grade salt 100.

The process also comprises a step of determining the zeta potential and/or of measuring the ionic mobility. The z-potential measurement can be based on a titration responsive to pH, to electric conductivity, to density, to viscosity or to the concentration of determined additives.

To this purpose, in apparatuses 200, 300 and 400 diagrammatically shown in FIGS. 11-13, a zeta potential measurement instrument 99 can be provided comprising a sample-taking connection arranged along a pipe 59 downstream of Venturi-type duct 50 (FIG. 13), or comprising a sample-taking connection at a location selected between the inside of reservoir 20 and the inside of a sample-taking pipe 36 coming from reservoir 20, equipped with the partially submerged feed duct 46 for gas 7 (FIGS. 12 and 14), for example downstream of pump 36. As an alternative, a sample-taking tap can be provided instead of measurement instrument 99, at the same location, through which a sample can be taken to be tested for a direct or indirect zeta potential measurement, in a measurement instrument, not shown, which does not belong to the apparatus.

Independently from zeta potential determinations, the quality of the liquid salt 100 can be characterized by measuring its density, pH, viscosity and composition.

Finally, the process according to FIGS. 2, 2A and 3 comprises a step 19 of storing the liquid food-grade salt 100, which includes storing it into a reservoir 60 and/or packing it into containers suitable for shipping and for industrial or home use.

FIGS. 4 and 5 show some modifications of the process according to FIGS. 2/2A and 3, respectively, from which they differ in that they provide a filtration step 13, in order to obtain a liquid food-grade salt so clear as possible. In particular, as still shown in FIGS. 11 and 12, a pump 35 is arranged for withdrawing solution 20 from reservoir 30 and for sending it to a filtration system 40.

In the case shown, filtration system 40 comprises a plurality of serially arranged filters 41, whose mesh size preferably decreases from a preceding filter to a subsequent filter, and is preferably set between 20 μm and 1 μm. In particular, four serially arranged filters 41 are provided whose mesh size is 20, 10, 5 and 1 μm, respectively.

FIGS. 6 and 7 show some modifications of the process according to FIGS. 2/2A and 3, respectively, from which they differ in that they provide a step 15 of adding iodine in an alimentary acceptable form, in order to obtain a salt adapted to supplement iodine. In particular, iodine is typically added in the form of iodide ions or of iodate ions, in particular potassium iodate KIO₃ or potassium iodide KI can be used or, in such a way to reach a iodine level established by the law, for example, in Italy, 30 ppm. Step 15 of adding iodine can be carried out in the same reservoir 30 where mixture 20 is prepared or prearranged, as shown in FIGS. 11-13.

The steps described with reference to FIGS. 2-7, along with the steps of preparing sodium chloride-containing solution 20, can be combined in different ways in order to obtain specific processes for preparing liquid food-grade salt having particular taste and nutrition features, and the like. For instance, FIGS. 9 and 10 show flow diagrams of methods comprising substantially all the steps described above.

These processes differ from one another in that they provide step 11 of adding anions 4 to mixture 20, selected for example among the above-listed anions, before a possible step 17 of causing gas bubbles 7, in order to obtain liquid salt low-sodium 100 from mixture 20 (FIG. 10) or, instead, they provide step 11′ of adding bicarbonate anions, and preferably also carbonate anions, to mixture 20 which is at least in part the same step of causing gas bubbles 7 to diffuse, during at least a period of time in which gas 7 contains carbon dioxide (FIG. 11).

The process of FIG. 9, which provides diffusion step 17 after filtration step 15 and before storing step 20, can be carried out by apparatus 300 of FIG. 12, in which diffusion duct 50 is installed downstream of filtration system 40 and upstream of the storage reservoir. However, such a process can be actuated even without diffusion duct 50, by a modification, not shown, of apparatus 400 of FIG. 13, in which partially submerged feed duct 46 is mounted to a reservoir that is arranged downstream of filtration system 40 and is different from reservoir 30, for example it can be storage reservoir 60.

On the other hand, a modification, not shown, of the process of FIG. 9, in which filtration 14 of liquid food-grade salt 100 is carried out after diffusion step 17 of gas 7, can be carried out by apparatus 400 of FIG. 13.

The process of FIG. 10, which provides diffusion step 17 before filtration step 14, can be carried out by apparatus 400 of FIG. 13, in which partially submerged feed duct 46 for feeding gas 7, at least in part containing a carbon dioxide fraction, is installed in reservoir 30, where mixture 20 is prepared, upstream of filtration system 40. However, this process can be carried out even by diffusion duct 50 in a modification, not shown, of apparatus 300 in which diffusion duct 50 is installed upstream of filtration system 40, and in which diffusion duct 50 is fed with gas 7 at least in part containing a carbon dioxide fraction.

On the other hand, a modification, not shown, of the process of FIG. 10, in which a filtration 14 of mixture 20 is carried out before diffusion step 17 of gas 7, can be carried out in apparatus 200 of FIG. 11, provided that a gas 7, at least in part containing a carbon dioxide fraction, is allowed to be sucked into diffusion duct 50.

### EXAMPLES

Mixtures have been prepared based on sodium chloride water solutions and also containing predetermined amounts of anions selected from the group consisting of: acetate anions, ascorbate anions, citrate anions, propionate anions, tartrate anions and sorbate anions.

Some of these mixtures contained different amounts of a same anion. The zeta potential and the ionic mobility of samples of these mixtures have been measured by a MALVERN ZETASIZER NANO ZS-90 instrument, exploiting the principle of the electrophoretic light scattering. To this purpose, all the samples have been diluted 100-fold in a 50 ppm agar colloidal solution prepared starting from the solid polysaccharide and ultrapure water. This dilution was necessary to increase ionic activity and analysis sensitivity.

### Example 1: (Reference) Sodium Chloride Solution Close to the Saturated State

3300 litres of water treated by reverse osmosys have been prearranged In a reservoir equipped with a stirring means. 1100 kg of rock salt have been added into the same container, obtaining a 25% wt sodium chloride water solution.

The zeta potential and of the ionic mobility of this solution have been determined by the above-mentioned instrument. The measurement results are summarized in table 1, along with those of the mixtures according to the invention.

### Example 2: Preparing a Liquid Low-Sodium Food-Grade Salt from Rock Salt and Integral Sea Salt

5,000 litres of water treated by reverse osmosis have been prearranged In a reservoir equipped with a stirring means. 710 Kg of sea salt, 1100 kg of rock salt and 60 Kg of potassium acetate (CH₃COOK) have been added in the same container. The sea salt, which contains bicarbonate ions, and the potassium acetate provide the anions required by the process.

The solid sea salt had the following composition, where the concentration of the anions is indicated:
Sodium chloride (NaCl) . . . 86.0%;
Bicarbonate ion (HCO₃_{^{−}}) . . . 0.41%;
Bromide ion (Br⁻) . . . 0.20%;
Borate ion (BO₃³⁻) . . . 0.08%;
Fluoride ion (F⁻) . . . 0.001%,
   present also ions sulphate, potassium, magnesium, calcium.

After 30 minutes' stirring, a solution was obtained having a density of 1.185 g/cm³, the composition of which is indicated below:
Sodium chloride . . . 24.9%
Bicarbonate ion (HCO₃_{^{−}}) . . . 0.042%;
Acetate ion (CH₃COO⁻) . . . 0.53%;
Borate ion (BO₃³⁻) . . . 0.008%; (total anions according to the invention . . . 0.58%)
Bromide ion (Br⁻) . . . 0.021%.

The solution has been pumped to a filtration system comprising three filters arranged in series, of 10, 5, and 1 μm mesh size, in order to obtain a fully clear liquid low-sodium food-grade salt according to the invention.

In a modification, after the filtration, such a solution has been caused to flow through the main passageway of a Venturi-type duct having the size indicated below:
water solution inlet and outlet diameter: 2″;
air inlet diameter: ½″,
   so the diameter ratio was 4:1. The Venturi-type duct was fed as follows:
water solution: 25-30 m³/h, with a pressure drop from 3÷7 bar g to 0÷1 bar g;
air: 37-49 Nm³/h.

This way, the kinetic energy increased and an amount of air was incorporated in the solution. By this step, a maximum sodium ion ionic mobility has been achieved, which is responsible for the salty taste, and a liquid low-sodium food-grade salt was obtained. Finally, the solution has been sent to a storage reservoir.

### Example 3: Preparing a Liquid Low-Sodium Food-Grade Salt from Rock Salt by Addition of Different Amounts of Sodium Bicarbonate, and Determining the Zeta Potential and the Ionic Mobility

In a reservoir equipped with a stirring means, 2000 litres of water treated by reverse osmosis, 676 kg of rock salt and 27 Kg of sodium bicarbonate (NaHCO₃) have been prearranged. The latter provides the anions required by the process.

After 30 minutes' stirring, a first mixture was obtained having a density of 1.187 g/cm³ and the following weight composition:
Sodium chloride: . . . 25.0%
Sodium bicarbonate: . . . 1.0% (as Bicarbonate ion HCO₃_{^{−}}): . . . 0.73%)
   The mixture has been pumped to a filtration system comprising three filters arranged in series, of 10, 5, and 1 μm mesh size, in order to obtain a clear mixture.

A second mixture has been obtained in the same way, using 2000 litres of water treated by reverse osmosis, 695 kg of rock salt and 83.5 Kg of sodium bicarbonate, and had the following weight composition:
Sodium chloride (NaCl): . . . 25.0%
Sodium bicarbonate: . . . 3.0%
(as Bicarbonate ion HCO₃_{^{−}}): . . . 2.18%)

The, the zeta potential and the ionic mobility of both mixtures have been determined. The results are given in table 1.

### Example 4: Preparing a Liquid Low-Sodium Food-Grade Salt from Rock Salt and Adding CO₂(g) to Provide Bicarbonate Ions

5,000 litres of water treated by reverse osmosis and 1,667 kg of rock salt have been prearranged in a first dissolution reservoir. After 30 minutes' stirring, a 25% weight sodium chloride solution was obtained.

In the same reservoir, the pH was adjusted to 9.5 by adding 1.3 litres of a 10% w/v potassium hydroxide solution.
Then, the solution has been sent to a second reservoir equipped with a bubbling means where a gas containing carbon dioxide and air was absorbed in the solution obtained after pH adjustment, and a food-grade salt was obtained according to the invention. The gas feed has been discontinued when the pH had reached 7.6. at this pH value, bicarbonate ion is the prevailing chemical species, and acts like a shield of the sodium ion, keeping the chloride ion at a distance form it. The incorporated air enhances Na⁺ ionic mobility, reaching thus a maximum freedom, which is necessary for obtaining a maximum tastefulness of the product.
Subsequently, the salt solution has been pumped to a plurality of four filters comprising cartridge of 20, 10, 5 and 1 μm mesh size, and then has been sent to the storage reservoir.

The weight composition of the liquid low-sodium food-grade salt obtained this way was:
Sodium chloride (NaCl): . . . 25%;
Bicarbonate ion (HCO₃_{^{−}}): . . . 0.2%.

### Example 5: Preparing a Liquid Low-Sodium Food-Grade Salt from Rock Salt by Addition of Different Amounts of Sodium Carbonate, and Determining the Zeta Potential and the Ionic Mobility

2000 litres of water treated by reverse osmosis, 695 kg of rock salt and 83.5 Kg of sodium carbonate (Na₂CO₃) have been prearranged in a reservoir equipped with a stirring means. The latter provides the anions required by the process.

After 30 minutes' stirring, a first mixture was obtained having a density of 1.19 g/cm³ and the following weight composition:
Sodium chloride (NaCl): . . . 25.0%
Sodium carbonate: . . . 3.0%
(as carbonate anion CO₃²⁻: . . . 1.7%)
   The mixture has been pumped to a filtration system comprising three filters arranged in series, of 10, 5, and 1 μm mesh size, in order to obtain a clear mixture.

A second mixture has been obtained in the same way, using 2000 litres of water treated by reverse osmosis, 714 kg of rock salt and 143 Kg of sodium carbonate, and had the following weight composition:
Sodium chloride (NaCl): . . . 25.0%
Sodium carbonate: . . . 5.0%
(as carbonate anion CO₃²⁻): . . . 2.8%)

Then, the zeta potential and the ionic mobility of both mixtures have been determined. The results are given in table 1.

### Example 6: Preparing a Liquid Low-Sodium Food-Grade Salt from Rock Salt, by Adding Different Amounts of Sodium Tartrate, and Determining the Zeta Potential and the Ionic Mobility

2000 litres of water treated by reverse osmosis, 678 kg of rock salt and 33 Kg of sodium tartrate dihydrate (Na₂C₄H₄O₆.2H₂O) have been prearranged in a reservoir equipped with a stirring means. The latter provides the anions required by the process.

After 30 minutes' stirring, a first mixture was obtained having a density of 1.188 g/cm³ and the following weight composition:
Sodium chloride (NaCl): . . . 25.0%
Sodium tartrate: . . . 1.0%
(as tartrate anion C₄H₄O₆²⁻): . . . 0.76%)
   The mixture has been pumped to a filtration system comprising three filters arranged in series, of 10, 5, and 1 μm mesh size, in order to obtain a clear mixture.

A second mixture has been obtained in the same way, using 7′300 litres of water treated by reverse osmosis, 2500 kg of rock salt and 200 Kg of potassium tartrate hemihydrate (C₄H₄O₆K₂.½H₂O), and had the following weight composition:
Sodium chloride (NaCl): . . . 25.0%
Potassium tartrate: . . . 1.9%
(as tartrate anion C₄H₄O₆²⁻: . . . 1.25%)

A third mixture has been obtained in the same way, using 2000 litres of water treated by reverse osmosis, 700 kg of rock salt and 100 Kg of sodium tartrate dihydrate, and had the following weight composition:
Sodium chloride (NaCl): . . . 25.0%
Sodium tartrate: . . . 3.0%
(as tartrate anion C₄H₄O₆²⁻): . . . 2.3%)

Then, the zeta potential and the ionic mobility of the mixtures have been determined. The results are given in table 1.

### Example 7: Preparing a Liquid Low-Sodium Food-Grade Salt from Rock Salt by Addition of Different Amounts of Sodium Citrate, and Determining the Zeta Potential and the Ionic Mobility

In a reservoir equipped with a stirring means, 2000 litres of water treated by reverse osmosis, 677 kg of rock salt and 31 Kg of sodium citrate dihydrate (C₆H₅Na₃O₇.2H₂O) have been prearranged. The latter provides the anions required by the process.

After 30 minutes' stirring, a first mixture was obtained having a density of 1.189 g/cm³ and the following weight composition:
Sodium chloride (NaCl): . . . 25.0%
Sodium citrate: . . . 1.0%
(as citrate anion C₆H₅O₇³⁻) . . . 0.73%
   The mixture has been pumped to a filtration system comprising three filters arranged in series, of 10, 5, and 1 μm mesh size, in order to obtain a fully clear solution.

A second mixture has been obtained in the same way, using 2000 litres of water treated by reverse osmosis, 700 kg of rock salt and 95 Kg of sodium citrate dihydrate, and had the following weight composition:
Sodium chloride (NaCl): . . . 25.0%
Sodium citrate: . . . 3.0%
(as citrate anion C₆H₅O₇³⁻) . . . 2.2%

A third mixture has been obtained in the same way, using 2000 litres of water treated by reverse osmosys, 722 kg of rock salt and 165 Kg of sodium citrate dihydrate, and had the following weight composition:
Sodium chloride (NaCl): . . . 25.0%
Sodium citrate: . . . 5.0%
(as citrate anion C₆H₅O₇³⁻) . . . 3.7%

Then, the zeta potential and the ionic mobility of the mixtures have been determined. The results are given in table 1.

### Example 8: Preparing a Liquid Low-Sodium Food-Grade Salt from Rock Salt and Potassium Chloride, by Adding Different Amounts of Potassium Citrate

A first mixture has been prepared by arranging 7′200 litres of water treated by reverse osmosys, 1500 kg of rock salt, 1200 Kg of potassium chloride and 100 kg of potassium citrate (K₃C₆H₅O₇) in a reservoir equipped with a stirring means, the latter compound providing the anions required by the process and compensating for the bitter taste of potassium chloride.

After 30 minutes' stirring, a saline solution was obtained of density 1.19 g/cm³ and the following composition:
Sodium chloride: . . . 15%
Potassium chloride: . . . 12%
Potassium citrate: . . . 1%
(as citrate anion C₆H₅O₇³⁻: . . . 0.62%)
   The solution has been pumped to a filtration system comprising three filters arranged in series, of 10, 5, and 1 μm mesh size, in order to obtain a fully clear solution.
   After the filtration, the mixture has been caused to flow through the main passageway of a Venturi-type duct. The size of the Venturi-type duct and the feeding conditions were the same as Example 2. Finally, the solution was sent to a storage reservoir.

A second mixture has been prepared as described above, but using 7,200 litres of water treated by reverse osmosys, 1540 kg of rock salt, 1230 Kg of potassium chloride and 30 kg of potassium citrate monohydrate (K₃C₆H₅O₇.H₂O), and had the following weight composition:
Sodium chloride: . . . 15.4%
Potassium chloride: . . . 12.3%
Potassium citrate: . . . 0.28%
(as citrate anion C₆H₅O₇³⁻: . . . 0.17%

The results of zeta potential and ionic mobility measurements are given in table 1.

### Example 9: Preparing a Liquid Low-Sodium Food-Grade Salt from Rock Salt, Potassium Sorbate and Potassium Citrate

In a reservoir equipped with a stirring means, 5,000 litres of water treated by reverse osmosys, 1685 kg of rock salt, 7 Kg of potassium sorbate (C₆H₇KO₂) and 50 kg of potassium citrate monohydrate (K₃C₆H₅O₇.H₂O) have been prearranged.

After 30 minutes' stirring, a saline solution was obtained which had a density of 1.187 g/cm³ and the following composition:
Sodium chloride: . . . 25%
Potassium sorbate: . . . 0.1%
(as sorbate anion C₆H₇O₂_{^{−}} . . . 0.074%
Potassium citrate: . . . 0.7%
(as citrate anion C₆H₅O₇³⁻: . . . 0.43%)
(total anions according to the invention . . . 0.504%)
   The solution has been pumped to a filtration system comprising three filters arranged in series, of 10, 5, and 1 μm mesh size, in order to obtain a fully clear solution.

### Example 10: Preparing a Liquid Low-Sodium Food-Grade Salt from Rock Salt and Potassium Propionate

5,000 litres of water treated by reverse osmosys, 1673 kg of rock salt and 20 Kg of potassium propionate (C₃H₅KO₂) have been prearranged in a reservoir equipped with a stirring means.

After 30 minutes' stirring, a saline solution was obtained of density 1.185 g/cm³ and the following composition:
Sodium chloride: . . . 25%
Potassium propionate: . . . 0.3%
(as sorbate anion C₃H₅O₂_{^{−}} . . . 0.2%)
   The solution has been pumped to a filtration system comprising three filters arranged in series, of 10, 5, and 1 μm mesh size, in order to obtain a fully clear solution.

TABLE 1

| | | Z-potential | Ionic mobility |
|---|---|---|---|
| Examples | Anions % | mV | μm · cm/Vs |
| 1 | NaCl reference solution | −7.07 | −0.5546 |
| 3 | HCO₃⁻ 0.73% | −8.38 | −0.6566 |
| 3 | HCO₃⁻ 2.18% | −9.84 | −0.7711 |
| 5 | CO₃⁼ 1.70% | −10.70 | −0.8388 |
| 5 | CO₃⁼ 2.80% | −13.5 | −1.0620 |
| 6 | Tartrate 1.25% | −8.76 | −0.6864 |
| 6 | Tartrate 2.30% | −10.80 | −0.8473 |
| 7 | Citrate 0.73% | −11.50 | −0.8988 |
| 7 | Citrate 2.20% | −10.40 | −0.8115 |
| 7 | Citrate 3.70% | −9.88 | −0.7742 |

The same measurements were carried out for other mixtures, which were obtained by adding anions to sodium chloride water solutions, wherein the anions were selected from the group consisting of: acetate, ascorbate, citrate, propionate, tartrate and sorbate, in an amount set between 0.1% and 5% of the weight of the respective mixture have been subject to measure the like. These further measurements confirmed the results shown in FIG. 1, i.e. these additions involve an increase of the absolute value of the zeta potential and of the ionic mobility, in the indicated measurement conditions. The higher the ionic mobility, always the higher the zeta potential, in absolute value, and vice-versa.

Taste trials have been also performed, which confirmed that the higher a mixture zeta potential and ionic mobility, the more intense was the salty taste the mixture provides.

The foregoing description of examples of processes to make liquid low-sodium food-grade salt will so fully reveal the invention according to the conceptual point of view, so that others, using the prior art, will be able to modify and/or adapt in various applications these examples without further research and without parting from the invention and, accordingly, it is meant that such adaptations and modifications will have to be considered as equivalent to the specific examples. The means and the materials to perform the different functions described herein could have a different nature without, for this reason, departing from the field of the invention. It is to be understood that the phraseology or terminology that is employed herein is for the purpose of description and not of limitation.

1-19. (canceled)

20. A process for making a liquid food-grade salt (100), comprising steps of:
preparing a mixture of:
an amount of water;
an amount of sodium chloride of from 14% and 26% by weight;
an amount of an alimentary acceptable salt of alimentary acceptable anions selected from the group consisting of bicarbonate anions, carbonate anions, borate anions; iodate anions; acetate anions; ascorbate anions; citrate anions; propionate anions; tartrate anions; sorbate anions; and a combination thereof,
wherein said alimentary acceptable anions are present in an amount of from 0.1% and 5% by weight,
wherein said amount of water is the complement to 100% of said mixture,
said alimentary acceptable anions optionally containing iodate ions,
said mixture optionally containing an amount of potassium chloride lower than 13% by weight with respect to the sum of said amount of water, of said amount of sodium chloride and of said amount of potassium chloride,
causing bubbles of a gas to diffuse through said mixture, said gas comprising any of air, helium, argon, and a combination thereof, said step of causing bubbles of a gas to diffuse selected from the group comprised of:
causing said mixture to flow through a diffusion duct that has an inlet port and an outlet port defining a passageway of said mixture, and has an intermediate restricted throat section, in particular through a Venturi-type duct, and simultaneously sucking gas to be diffused at said throat section, by said mixture flowing through said passageway, in such a way that an emulsion is formed, i.e. a metastable state is formed that temporary accumulates energy;
a step of bubbling said gas in a reservoir containing said mixture, comprising a step of supplying said gas to said reservoir through a delivery mouth in use arranged below the level of said mixture, and having a supply head configured for forming and delivering gas bubbles whose size is at most micrometric,
measuring the ionic mobility of said mixture, after starting said step of diffusing said bubbles of gas,
wherein said step of causing said bubbles of said gas to diffuse is continued until a ionic mobility of said mixture is reached that is higher than a predetermined value above a ionic mobility of a sodium chloride reference water solution containing the same amounts of water, sodium chloride and said alimentary acceptable anions, said reference water solution not subjected to said step of causing bubbles to diffuse.

21. The method according to claim 20, wherein said mixture contains an amount of potassium chloride lower than 13% by weight with respect to the sum of said amount of water, of said amount of sodium chloride and of said amount of potassium chloride, and said amount of anions (4) comprises citrate anions in a proportion of from 1% and 9% by weight with respect to the weight of potassium chloride.

22. The method according to claim 20, wherein said amount of anions is selected in such a way to obtain a zeta potential of said mixture higher than a zeta potential of a sodium chloride water solution comprising the same amounts of water and of sodium chloride.

23. The method according to claim 20, wherein said amount of anions is selected in such a way to obtain a ionic mobility of said mixture higher than a ionic mobility of a sodium chloride water solution comprising the same amounts of water and of sodium chloride.

24. The method according to claim 20, wherein said amount of sodium chloride is from 18% and 26% by weight.

25. The process according to claim 20, wherein said amount of sodium chloride is from 23% and 26% by weight, in particular from 24.5% and 25.5%, more in particular, said amount of sodium chloride is about 25% weight.

26. The method according to claim 20, wherein said amount of alimentary acceptable anions is from 0.1% and 0.5% by weight.

27. The process according to claim 20, wherein said step of causing said bubbles of said gas to diffuse comprises said step of causing said mixture to flow through a diffusion duct, wherein the ratio between the flowrate of said gas and the flowrate of said mixture (20) is from 0.3 and 2 Nm³/m³, in particular from 0.5 and 1 Nm³/m³.

28. The process according to claim 20, wherein said alimentary acceptable anions comprise bicarbonate anions;
said gas also contains a carbon dioxide volume fraction of from 10% and 30%, in particular from 15% and 25%;
said step of causing said bubbles of said gas to diffuse through said mixture is continued until an amount of bicarbonate ions is added at most equal to said amount of anions.

29. The process according to claim 28, wherein, before said step of causing said bubbles of said gas to diffuse, a step is provided of adding an alkaline agent to said mixture, in order to adjust the pH of said mixture to an initial pH value from 8 and 8.5, and said step of diffusion of an amount of said gas containing carbon dioxide proceeds until a predetermined final pH value of from 7.2 and 7.8 is reached, in particular, said predetermined final pH value is about 7.5.

30. The process according to claim 20, wherein said step of preparing said mixture comprises:
prearranging said amount of water having an electric conductivity at most equal to 10 μS, wherein said water is selected between a water treated by reverse osmosis and distilled water;
prearranging said amount of alimentary acceptable solid sodium chloride, said solid sodium chloride selected from the group consisting of:
sodium chloride extracted from an underground salt mine;
sodium chloride obtained by crystallizing a saturated sodium chloride solution, and
dissolving said amount of solid sodium chloride into said amount of water.

31. The process according to claim 30, wherein said step of preparing said mixture comprises a step of feeding a compound adapted to form, when brought into contact with said water, one of said alimentary acceptable anions, in particular said compound is an alimentary acceptable salt of one of said alimentary acceptable anions.

32. The process according to claim 30, wherein said solid sodium chloride comprises an amount of sea salt that has a known concentration of said alimentary acceptable anions, said amount of sea salt selected to provide to said mixture an amount of said alimentary acceptable anions that is at most equal to said predetermined amount of anions, in particular, said amount of said sea salt is from 10% and 40% by weight with respect to said solid sodium chloride, more in particular from 18% and 25% weight, even more in particular about 20%.
